(19) United States
(12) Patent Application Publication
(10) Pub. No.: US 2019/0385125 A1
(43) Pub. Date: Dec. 19, 2019

(54) METHOD AND SYSTEM FOR MANAGING WORKFORCE

(71) Applicant: Serveture LLC, Atlanta, GA (US)

(72) Inventors: Steven Blakely, Atlanta, GA (US); Jakob Rohn, Atlanta, GA (US)

(21) Appl. No.: 16/442,934

(22) Filed: Jun. 17, 2019

Related U.S. Application Data
(60) Provisional application No. 62/685,604, filed on Jun. 15, 2018.

(51) Int. Cl. G06Q 10/10

(52) U.S. Cl. CPC G06Q 10/1053

(57) ABSTRACT

Disclosed herein is a system and method for managing workforce, for example, matching job or shifts with workers. The method may include receiving a plurality of worker values, a plurality of employer values corresponding to at least one attribute, and job values. The method may further include receiving an employer priority associated with an employer value. Subsequently, matching between workers and jobs may be performed based on comparison between worker values and employer values. Additionally, the method may include transmitting a work request to at least one matching worker according to an offer transmission sequence.

### CROSS REFERENCE TO RELATED APPLICATIONS

This application claims the benefit of priority to U.S. Provisional Application No. 62/685,604 filed Jun. 15, 2018, which is herein incorporated in its entirety.

### FIELD OF INVENTION

The present invention generally relates to methods, systems and devices for staffing and managing workers.

### BACKGROUND OF THE INVENTION

The current staffing and workforce management solutions are inflexible, in the sense that there are not many options provided for the employers to customize worker profiles in their workforce. The current staffing solutions do not offer efficient parameters to allow the employer to enhance the match between an open job and worker from their workforce. Further, the algorithms used for matching workers with open shifts and jobs are not intelligent enough to provide a good fit which results in the open shift being successfully filled a worker. Further, the current matching techniques match worker and employer profiles based on limited keywords and factors. Due to the limited parameters considered for matching the profiles, the worker candidates may not satisfy the expectations of the employer or job.

Accordingly, there is a need for improved methods and systems for matching work request from employers with workers. There is also a need for method and system which utilize additional factors and parameters from the profiles of the workers and employers for providing the matches according to a ranking or score. These needs and other needs are met by the various aspects of the present disclosure.

### SUMMARY OF THE INVENTION

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed herein is a system and method of staffing jobs with workers. The method may include receiving, using a processor, a worker profile comprising a plurality of worker values corresponding to one or more attributes. Further, the method may include receiving, using a processor, an employer profile comprising a plurality of employer values corresponding to one or more attributes. Further, the method may include receiving, using a processor, a job profile comprising a plurality of job values corresponding to one or more attributes. Furthermore, a worker priority associated with a worker value and/or job value may be received. Further, the method may include receiving, using a processor, an employer priority associated with a worker value and/or job value. Furthermore, the method may include receiving, using a processor, a job priority associated with a job value.

In various aspects, a worker score associated with each worker may be determined, using a processor. Further, the worker score associated with a worker may be determined based on at least one of: a comparison of at least one of: worker profiles, worker values with a plurality of job values, a comparison of worker values with a plurality of employer values, and a comparison of the worker score with the employer priority.

In some embodiments, the one worker priority and/or the employer priority may comprise a maximum value and a minimum value. In other embodiments, a worker score associated with a worker from a plurality of workers may be determined based on each of a value-distance between the plurality of worker values and the plurality of employer values and/or a priority-distance between the worker priority and the employer priority.

In some embodiments, a selection of the plurality of attributes for a worker and a job may be received using a processor. In other embodiments, the method may further include receiving, using a processor, an employer priority corresponding to an attribute of the plurality of attributes. Furthermore, the worker score may be determined based further on a comparison of worker profile data corresponding to an attribute with the employer priority corresponding to the attribute.

In some embodiments, a plurality of worker profiles corresponding to the plurality of workers matching predetermined criteria may be displayed using a processor. The displaying of the worker profiles may be performed based on the worker score associated with each worker from the plurality of workers. In other embodiments, displaying of the worker profiles may be performed in response to posting a job by an employer.

In some embodiments, a candidate pool of workers meeting predetermined criteria from the plurality of workers may be determined. Further, at least one work request or job offer may be transmitted to at least one worker among the candidate pool. In further aspects, an offer transmission sequence for transmitting the at least one offer to the at least one worker from the candidate pool may be determined. In still further aspects, the at least one offer to at least one worker from the candidate pool may be transmitted according to the offer transmission sequence.

In some embodiments, the method may include receiving, using a processor, offer input data corresponding to a job profile of the plurality of job profiles. Further, an offer corresponding to the job profile may be transmitted to one or more workers. Further, the offer may be transmitted to a plurality of workers. Further, the offer may include a job or unfilled shift and one or more offer parameters, such as, for example, a time period to accept the offer. In some aspects, the offer may be simultaneously transmitted to a plurality of workers. In other aspects, the offer may be sequentially transmitted to individual workers from a plurality of workers.

In some embodiments, displaying of a job profile of the plurality of job profiles may be based on predetermined criteria provided by an employer associated with the job profile. The predetermined criteria may forbid displaying job profiles to workers that have worker profile data in their worker profile that does not meet predetermined acceptance criteria or meets restriction criteria set by the employer.

In other embodiments, transmitting an offer may be based on predetermined criteria provided by an employer associated with the job profile. The predetermined criteria may forbid transmitting and offer to workers associated with worker profile data that meets restriction criteria set by the employer.

In various embodiments, the method may further include receiving, using a processor, a request for viewing profile data. Further, a grant for viewing of profile data may be received. Further, displaying of the profile comprising some or all profile data may be based on the grant.

In some embodiments, a plurality of job postings corresponding to one or more employers may be displayed. In other embodiments, displaying of job postings may be performed in response to a selection of a job profile.

In some embodiments, the method may include retrieving, using a processor, worker profile data corresponding to a worker. Further, at least a part of a job profile associated with a worker of the plurality of workers may be generated, using a processor, based on the profile data.

In some embodiments, a data source for performing the retrieving may be an employer database or governmental database. In other embodiments, each worker may be associated with one or more job profiles, wherein a content and a form of the job profile may be based on a governmental regulation.

In some embodiments, the method may further include detecting, using a processor, a conflict based one or more worker values. In other embodiments, a conflict may be detected based on one or more employer values and/or one or more employer priorities, for example, a calendar conflict.

In further embodiments, a likelihood of offer acceptance corresponding to a worker of the plurality of workers may be predicted. Further, the predicting of the likelihood of offer acceptance may be performed based on an analysis of the plurality of worker values and/or the worker profile data.

Also disclosed may be a system for staffing work from a pool of workers and/or employees. The system may include a processor and a memory communicatively coupled to the processor. The memory may be configured to store program code which when executed by the processor, may cause the system to receive a plurality of worker values corresponding to an attribute of a plurality of attributes.

Further, the execution of the program code may cause the system to receive a plurality of employer values corresponding to the attribute of the plurality of attributes. Furthermore, the execution of the program code may cause the system to receive a worker priority associated with a worker value of the plurality of worker values. Further, the execution of the program code may cause the system to receive an employer priority associated with an employer value of the plurality of employer values. A worker score associated with each worker of a plurality of workers may be determined. Further, the worker score associated with a worker may be determined based on each of a comparison of the plurality of worker values with the plurality of employer values. Still further, a candidate pool of workers meeting predetermined criteria from the plurality of workers may be determined. Yet further, at least one work request or job offer may be transmitted to at least one worker among the candidate pool. Still further, an offer transmission sequence for transmitting the at least one offer to the at least one worker from the candidate pool may be determined. The at least one offer to at least one worker from the candidate pool may be transmitted according to the offer transmission sequence.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate several aspects of the invention and together with the description, serve to explain the principles of the invention. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a block diagram of an operating environment consistent with the present disclosure.

FIG. 2 illustrates a flow chart of a method of matching workers with job requests according to various embodiments.

FIG. 3 illustrates an exemplary view of the platform as presented to a worker according to an embodiment of the present invention.

FIG. 4 illustrates an exemplary view of the platform as presented to an employer according to an embodiment of the present invention.

FIG. 5 illustrates the method steps involved in computing worker scores according to various embodiments.

FIG. 6 illustrates a flow diagram of the method steps for matching workers with job requests according to various embodiments.

FIG. 7 illustrates an exemplary view of the platform provided to a worker in accordance with various embodiments.

FIG. 8 illustrates an exemplary view of the platform provided to an employer in accordance with various embodiments.

FIG. 9 illustrates a block diagram of a system for matching workers with employers according to various embodiments.

FIG. 10 illustrates a block diagram of a matching server configured to perform the disclosed methods.

### DETAILED DESCRIPTION

The present invention can be understood more readily by reference to the following detailed description of the invention and any examples included therein.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

It is also to be understood that the terminology used herein is for the purpose of describing particular aspects only and is not intended to be limiting. As used in the specification and in the claims, the term “comprising” can include the aspects “consisting of” and “consisting essentially of ” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of workforce management, embodiments of the present disclosure are not limited to use only in this context.

### A. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The disclosed methods and systems (also collectively referred to herein as the “platform”) may comprise a worker matcher. The job matcher may provide a deterministic method to compute a relative worker score between a worker and a job or open shift, based on a set of attributes of the worker and the employer's preferences for given values of the attributes.

In various aspects, the employer may comprise at least one of, but not limited to, an organization, and an employer customer, and a staffing company. In further aspects, a job may comprise at least one of: a job listing, job post, an open shift, a project, and a task. In still further aspects, the job may comprise a job profile. In yet further aspects, the job profile may comprise job profile data corresponding to attributes of the job. In even further aspects, the plurality of workers may comprise one or more predetermined pools of workers.

In further aspects, the worker score may represent a predicted or calculated level of likelihood that a worker will accept and/or complete a work request or job offer. In still further aspects, the worker score may represent a predicted or calculated level of satisfaction of the employer with the worker for a job. For example, a high worker or match score may indicate a predicted or calculated higher level of likelihood that when a work request is transmitted, the worker will accept the job and/or complete the job to the employer's satisfaction. The worker score may identify more preferable workers for a job for an employer, but in some aspects, it may not necessarily indicate a better match from the perspective of the worker.

In various aspects, computing worker scores may be a two-step process. Firstly, the employer may go through an exercise to create a “Profile” by selecting a subset of attributes or establishing criteria that may be most important to them. Thereafter, for each attribute selected, the employer may indicate the most important attribute value and the least important attribute value (a “max diff” attribute value selection). The profile may be then used to compute the worker score for any applicable job. Further, one or more worker scores may be presented to the employer to indicate relative matches between the employer or job preferences and the worker.

In the worker matcher, a set of independent attributes may be maintained common to all instances of a job or for an employer. Each attribute may have a discrete set of possible values, such that a given job or service either has a specific attribute value or does not have it. For example, an attribute related to a delivery job or a delivery driver who may be creating a profile in the worker matcher may be “experience”. The attribute “experience” may indicate the total driving experience needed to qualify for the job and/or the total driving experience of a worker.

In further aspects, each job may have one or more values for each attribute, however having at least one value for each individual attribute may not be required. Any job with no applicable values for a given attribute may automatically produce a lower worker score when matching workers if the attribute is selected by the employer.

In further aspects, attributes may be grouped into categories for presentation purposes, and selection of at least one attribute from each or any given category or categories may optionally be enforced as part of the worker matcher feature. The employer may create a profile representing the employer's preferences related to the attribute's values for the worker type and/or job type.

A full set of attributes may be presented to the employer along with a brief description to help the employer understand the meaning and/or purpose of the attribute. The employer selects the set of attributes that may be most important from his or her perspective in selecting a specific worker. A minimum and/or maximum number of selected attributes may be enforced during the attribute selection process. Attribute categories may be used, where the attributes may be displayed within the groups and any rules associated with enforcing selection of attributes from the attribute categories may be enforced.

Thereafter, the employer may use a rating process to provide relative ratings to the values for each attribute. All of the possible values for the attribute may be presented, and the employer may select the single “most important” and single “least important” value for the attribute from his or her perspective.

In some embodiments, a simple maximum differential (“Max Diff”) approach used in the worker matcher may provide an efficient way to get a relative rating for the possible values for each selected attribute. One attribute value may be identified as having the maximum relative importance, one the least relative importance, and the others a mid-level relative importance. This provides a relative rating for all possible attribute values, with one identified as having the maximum relative value, one the minimum relative value, and the rest an equal middle relative value. For attributes with small numbers of values, the worker matcher may provide a good relative rating for values. As the number of values for a given attribute increases, the larger number of values with the equivalent middle relative values may make differentiating matching values between the employer's preferences and the worker or job attribute values less clear. Further, tuning adjustments can be made for such attributes to improve the match scoring.

Non-limiting examples of attributes may include one or more of: work radius <scheduled only>, average star rating, average star rating with enterprise, average star rating with location, average star rating with requester, average star rating with sessions of given attributes, overtime propensity, work history with enterprise, work history with marketplace, work history with requester, work history with location, current proximity, and proximity of closest ending session, and others.

Once an employer and/or job profile is created, it may be used to compute worker values for all available workers in the platform or a designated worker pool. A score computing algorithm for computing the worker score values may be designed to generate a value between 0 (zero) and 100 (one hundred). The actual value may be meaningful only in relative terms to the worker score values for a certain job or employer. The algorithm may include various tuning parameters to optimize matching for different types of jobs and employers with different numbers and types of attributes.

The worker matcher algorithm may compute worker score values for an individual worker using the following process. The selected attributes from the employer profile and/or job profile may be given a weighted score between 0 and 100 based on the number of attributes selected or based on a predetermined weight.

For example, if 4 attributes are selected and equally weighted, then each attribute score weight for each attribute would be 0.25 (or 25%). For each selected attribute, the attribute values in the employer profile may be compared with the attribute values associated with the worker and/or job. Each attribute may have a “weight adjustment factor” which may be a value between zero and one. These values default to one, but may be tuned to give added weight or to reduce the weight of individual attributes.

The score for each component may be multiplied by the attribute's weight adjustment factor and then multiplied by the attribute score weight to determine that component's portion of the score. The individual component values may be added together to determine the worker score, which may be limited to maximum value of 100. In instances where weight adjustment factor values may result in a sum of greater than 100, the worker score may be simply assigned a value of 100, e.g. a “best match”.

In some embodiments, the worker score can have a 0 to 1.0 value for the worker score, which may be multiplied a given constant (e.g. 100) and provide a value to display in the range 0 to 100. However, depending on the attributes selected and the entities involved, it may be difficult to see a worker score at the top of the range (i.e. 1.0, or 100 as a display value). The attribute and matching factor adjustments can be used to tune the computation or to get values closer to 100 for better looking results. However, it may be important to recognize that the Match Scores may be relative scores that help identify that one worker as being preferable over another worker.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### B. Platform Configuration

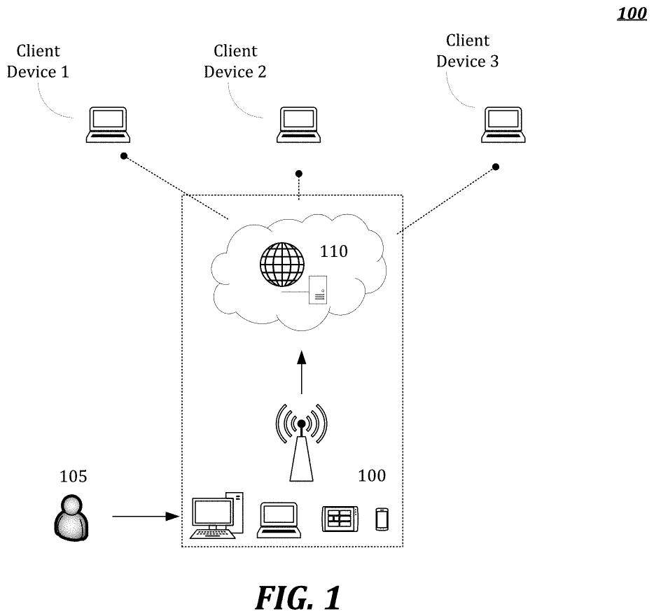

FIG. 1 illustrates one possible operating environment through which a platform consistent with embodiments of the present disclosure may be provided. The operating environment may comprise methods, systems, and devices collectively referred to as a platform. The platform may include a matching server 100 in communication with client devices such as client device 1-3. The communication may be performed over a network 110. Although the present disclosure refers to various functions and operations performed by particular components of the platform (e.g., profile matching server or client devices), it should be understood that some platform components may be interchanged with others, and/or, where necessary, combined with other components to perform the functions and operations intended.

By way of non-limiting example, a matching server 100 may be interconnected using a network 110. In some embodiments, network 110 may comprise a Local Area Network (LAN), a Bluetooth network, a Wi-Fi network and a cellular communication network. In other embodiments the profile matching platform may be hosted on a centralized server, such as, for example, a cloud computing service. A user 105 (e.g., a worker, an employer) may access platform 100 through a software application. The software application may be embodied as, for example, but not be limited to, a website, a web application, a desktop application, and a mobile application compatible with a matching server 100. One possible embodiment of the software application may be provided by matching software, which may include a score computing algorithm, executed on the matching server 100 and remotely accessible using electronic devices such as laptop or tablet computers.

As will be detailed with reference to FIG. 1 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

The matching server 100 may be configured to communicate with each of client devices 1-3 over the network 110. Further, the matching server 100 may be configured to provide a user interface to the user 105. Accordingly, the user 105 may interact with the profile matching server 100 in order to create a profile which may include one more attributes associated with the user 105. For example, the matching server 100 may display a GUI to the user 105 in order to provide values to one or more attributes of a profile and set appropriate levels of priorities to the values associated with the attributes of the profile. Further, the GUI may enable the user 105 to select a priority level corresponding to the attributes of the profile. The user 105 may be, for example, a worker or an employer. Subsequently, the matching server 100 may be configured to compute a worker score based on the values of the attributes and the corresponding priorities thereof. Thereafter, the matching server 100 may be configured to match employers and/or jobs with suitable worker profiles and generate a list of best matched profiles. The matching server 100 may be configured to then transmit work requests or job offers to the best matched workers according to an offer transmission sequence.

### C. Platform Operation

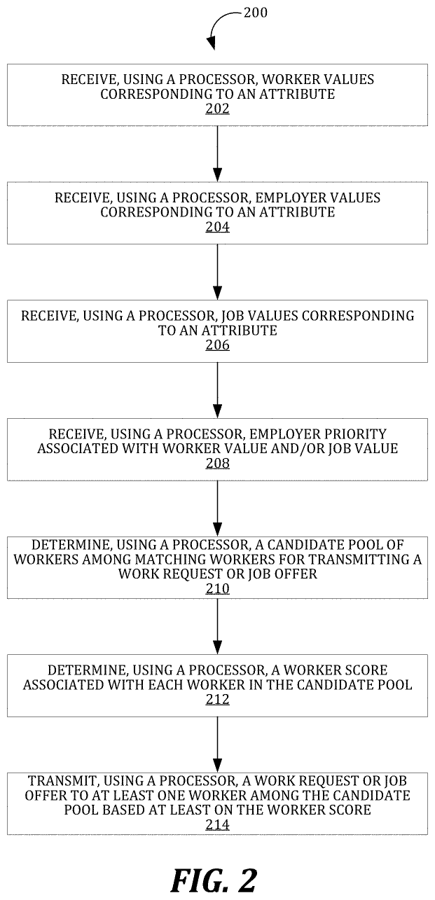

FIG. 2 illustrates a flow chart of a method of matching workers with jobs and/or employers, in accordance with various embodiments. Typically, a worker matching service may require both the worker and the employer to establish profiles within the platform. In one such instance, a worker may register within the platform by creating an account. The registration may begin with the worker assigning an email ID and a password for the account. Thereafter, the worker may provide a value to a number of attributes which may be a part of the profile. The attributes may include for example, personal and professional details of the worker. The personal details may include, for example, name, date of birth, address and contact number. The professional details may include duration experience in a particular profession, expertise in a certain skill set, educational background and the like.

For example, the worker may be a driver. The driver may provide values to the one or more attributes of the profile. The professional attributes for the driver may include schedule, location, experience, and others. Further, the attributes may include the types of vehicles driven, cargo type handled, and/or the routes which the driver has driven. In further aspects, an employer who may be seeking to find suitable workers may establish one or more profiles. The employer may fill in one or more values to the attributes which may be used to calculate worker scores and/or displayed to the worker. The employer may provide values of the organizational and job posting related attributes. In one instance, the employer may be a logistics company looking for suitable workers to fill one or more delivery routes. The employer may first establish an employer profile and fill in the values for the attributes pertaining to the organization. Thereafter, the employer may establish one or more job posting within the platform. For each job posting, the employer may fill in values for the attributes associated with the particular job posting. For example, the logistics company may fill in the values for one or more attributes associated with the delivery routes. The attributes associated with the job posting may be, for example, work radius, average rating, average rating with enterprise, average rating with location, average rating with requester, average rating with sessions of given attributes, overtime propensity, work history with enterprise, work history with marketplace, work history with requester, work history with location, current proximity, and proximity of closest ending session, skill level, experience level, and other related qualifications.

Referring to FIG. 2, at step 202, worker values corresponding to an attribute may be received using a processor. As explained above, the attributes may be various parameters associated with the profile of the worker. For example, the attributes may be parameters associated with the personal and professional details of the worker, such as average rating with enterprise, average rating with location, average rating with requester, work history with enterprise, and work history with marketplace.

In further aspects, the worker may provide values to the attributes associated with the professional experience thereof. These attributes may be relevant to the job to which the worker may receive requests to work. In some embodiments, the worker may provide values as a part of the profile filling step. The attributes which may be filled may be used by the matching service at a later instance to determine suitable workers for job postings which matches the expectations of the employer. In some instances, the attributes may be presented to the worker when the worker receives offer request for work or a particular job from an employer. The particular job for which the worker received an offer may require the worker to fill values for a different set of attributes which may not be present in the profile of the worker. For example, the employer may request that that the worker have or confirm having a certain license type or certification for the particular job.

In some aspects, a worker priority associated with a worker value may be received using a processor. The worker priority may be a measure of a priority that the worker assigns for a particular worker value. In some embodiments, the worker priority may correspond to worker preferences. The worker preferences may indicate some aspects about the job which may be most important to the worker. In some embodiments, the worker priority may be a quantitative value associated with an attribute. For example, a worker may be a nurse with a number of skills in a domain. The nurse may be having expertise treating four patient types (P1, P2, P3 and P4). The nurse may furnish this information under the attribute skill set. Further, the nurse may be provided with an option to assign a priority to each of the skills in the skill set. For example, the nurse may provide a numerical value as the priority for the patient types in the skill set. The nurse may provide value of (8, 6, 4, 7) for the patient types, wherein the range of priority values available may be 1-10 with 10 representing highest priority. In some embodiments, the worker priority may be provided in terms of binary values. The binary values may be presented as options such as, but not limited to, “most important”, “least important”, “most preferred” and “least preferred”.

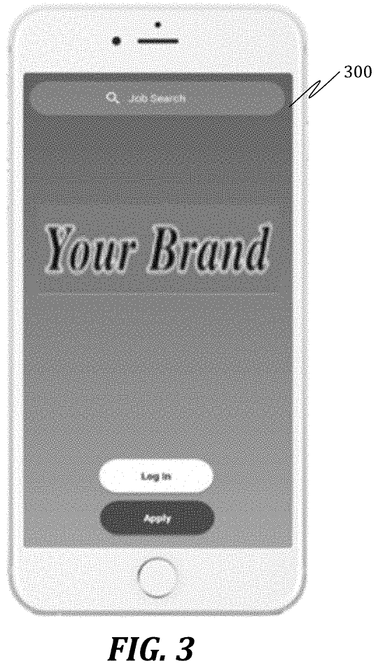

FIG. 3 shows view 300 of a graphical user interface (GUI) which may be presented to a worker for interacting with the platform, such for inputting data into the platform or providing worker values or searching for jobs. The view may be presented in the form of a website or an application which may be accessed using a mobile device. The view may include information associated with the profile of the worker. Further, the profile may include attributes for which the worker may provide values. Next to the attribute qualification, there may be a drop-down menu which may list all the relevant values. The worker may select the appropriate value based on the actual qualification thereof. Further to selecting the value for the attribute qualification, the worker may select a priority value for the same. The priority values (P₁, P₂ . . . P_{N}) may be assigned to each of the attributes based on a preference of the worker. For example, the worker may provide a lower priority for the value under the attribute qualification and provide a higher priority for the value under the attribute experience. In this manner, the worker may provide a higher weight to his/her experience rather than the educational qualifications. The attribute may include experience. The user may be provided with a drop-down menu which indicates various ranges of experience in years. The worker may select one of the options as a value to the attribute “Experience”. For example, the worker may select the experience as “>10 years”.

At step 204, employer values corresponding to the attribute may be received using a processor. The employer may provide values to one or more attributes as a part of completing a profile. The employer may provide values to attributes which relates to the company associated with the employer.

At step 206, the employer may also provide values to attributes associated with a job or shift which the employer needs to fill within the platform or marketplace. In an exemplary instance, the employer may provide values to one or more attributes for a job which may be identical with the attributes presented to the worker. In some embodiments, the employer may fill in values for additional attributes based on a particular job or shift. For instance, an employer may post a shift for nurse in a hospital. For this shift, the employer may fill in additional details such as area of hospital, type of patients, medical specialty, and the like.

At step 208, an employer priority associated with the employer value may be received using a processor. The employer priority may indicate a level of importance that the employer associates with the values of the attributes. For example, the employer may want to hire candidates who may be willing to travel 70% of the time. Now, travel requirement may be an attribute of the job posting. Under the attribute travel requirement, the worker may provide a priority to indicate that the candidate may travel 70% of the time.

In some embodiments, the employer may provide employer priority to indicate a level of skill desired for a particular job vacancy. For example, the employer may be a hospital filling nursing shifts. When the hospital may be posting an open shift or transmitting a work request within the platform, the employer may provide values to the attribute “Skillset”. The values under the attribute “Skillset” may be patient types P1, P2, P3 and P4. Further, the employer may assign employer priority for the values, indicating as to which patient types would be most acceptable to the employer for the shift. For example, the employer may provide priority values 5, 9, 7 and 3 for the patient types. Further, the employer may provide priority values to the values of the attributes in other ways such as binary preferences. For example, the employer may select choices such as “most important” and “least important” for the values of an attribute.

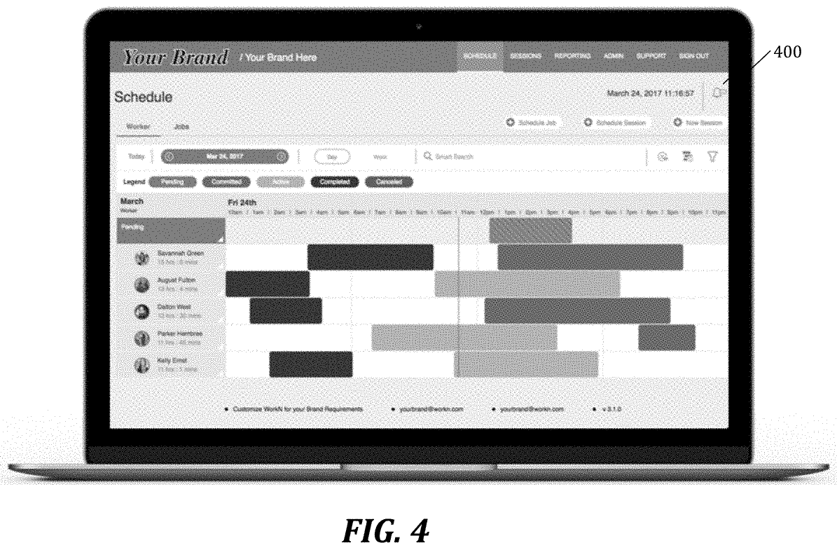

FIG. 4 shows view 400 of a graphical user interface (GUI) which may be presented to an employer for interacting with the platform, such as for providing employer values and employer priority or managing jobs. The employer may login to the platform using a respective account in order to fill in the attribute values and priority. The employer view may include a number of attributes such as, for example, qualification, experience, skill set and the like. For example, the employer may be provided with an attribute “Experience” for which the employer may furnish a value from the dropdown menu. Further, the employer may select a value for the attribute qualification. In this case, the employer may assign a priority value for the attribute. In an example, the employer may assign a high priority value for the qualification rather than experience. In other words, a higher priority value to the attribute qualification may indicate that the employer may be looking for candidates with a better qualification rather than experience.

At step 210, a candidate pool of workers among matching workers may be determined, using a processor. After the determining the worker scores, the scores may be used to match the best suited workers with the job employer and/or work request. The candidate pool of works may then be used to select one or more workers meeting predetermined criteria to transmit a work request or job offer. The candidate pool may be determined by considering the values of the attributes associated with the employer relative to the worker score. Additionally, the workers receiving work requests may be determined by considering the employer priority associated with the values of the employer attributes.

At step 212, a worker score associated with each worker in the candidate pool may be determined. The worker score may be a cumulative score computed by considering the values for one or more attributes and the priorities associated with the values. For example, the worker score may be computed by considering the worker values for the one or more attributes associated with the worker profile. Additionally, the worker score may be computed by considering the employer priorities and/or job attribute associated with the worker values.

At step 214, worker profiles may be displayed to the employer for transmitting work requests or job offers based on predetermined criteria and/or a match between the worker score and employer and/or job requirements using a processor. In some aspects, the employer may be provided with a list of best suited workers based on the worker scores in order to select worker to transmit work requests. In other aspects, the work requests may be automatically transmitted to the workers based on predetermined parameters and/or worker score. In further aspects, offer transmission sequence may be determined using the list of best suited workers for transmitting the work requests.

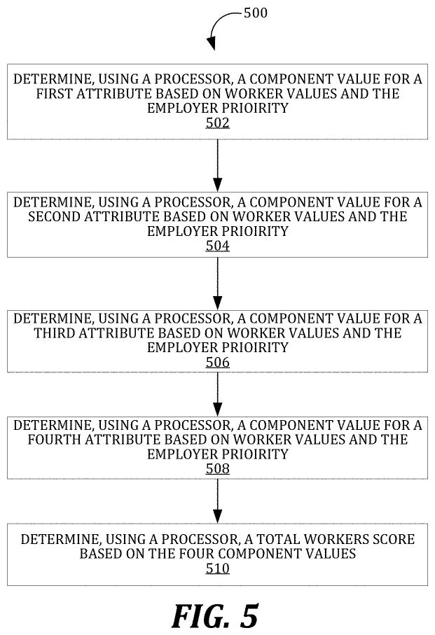

FIG. 5 illustrates steps of an exemplary method for in computing worker scores, in accordance with an embodiment. In various aspects, the basis for computing the score may be to determine the worker most likely to accept the job request and meet the expectations of the employer. In some aspects, a score may be computed for every worker profile. The score values may be computed to be a value between 0 (zero) and 100 (one hundred), where 100 indicates an optimal match and a zero indicates a bad match. The score computing algorithm may include various tuning parameters to optimize matching between the workers and jobs with different values and priorities for different attributes.

In further aspects, the worker score may be used to define the relative sort order and/or to prioritize qualified workers who would have normally received all offers simultaneously. In still further aspects, the worker score may be used to create a sort order or offer transmission sequence. The offer transmission sequence may be determined, using a processor. The sequence may be computed by considering the values of the attributes associated with the employer relative to the worker score. Additionally, the sequence may be determined using worker scores computing by considering the employer priority associated with the values of the employer attributes.

At step 502, an “average rating min/max relative value” component may be determined using a processor. In further aspects, all historical ratings may be considered and utilized to determine this component value and distribution order. In yet further aspects, the highest rated worker may get 100 or full 100% for this component towards the final worker score, and the lowest rating may get 0. In still further aspects, a worker between the top and lowest rated workers may get partial based on where they are in the distribution. For example, if this component is weighted as 25% of the total worker score then values can be calculated as follows: Worker A=4.7 stars=22% (e.g., 88% of the max); Worker B=4.6 stars=20% (e.g., 80% of the max); Worker C=4.9 stars=25% (e.g., 100% of the max); and Worker D=3.2 stars=0% (e.g., 0% of the max).

At step 504, another component of the worker score which may comprise “radius Proximity Min/Max Relative value <scheduled only>” and/or “current proximity Min/Max radius value” may be determined using a processor, which may include all distances to worksite from worker address. If this component was weighted as 20% of the total score, then values would be calculated as follows: Worker A=110 miles=0% (0% of max); Worker B=60 miles=10% (50% of max); Worker C=35 miles=5% (25% of max); and Worker D=10 miles=20% (100% of max).

At step 506, another component of the worker score which may comprise “Work History Marketplace Min/Max Spread” and/or “Work History Enterprise Min/Max Spread” and/or “Work History Location Min/Max Spread” and/or “Work History Requester Min/Max Spread” and/or “Work History Key Attribute Min/Max Spread” may be determined using a processor. If this component was weighted as 50% of the total score, then component values would be calculated as follows: Worker A=20 times=50% (100% of max); Worker B=5 times=12.5% (25% of max); Worker C=0 times=0% (0% of max); and Worker D=10 times=25% (50% of max).

At step 508, another component of the worker score which may comprise “Overtime Propensity Min/Max Spread” may be determined using a processor, which may be updated on a worker record at a predetermined interval by external system or internally calculated or both. The higher the number, the more likely they are to be in an overtime situation. In some aspects, this may be only valid for a given date range and may change frequently. When an offer or work request is transmitted, it may be assessed against the overtime status given the information at that point in time. If this component was weighted as 10% of the total score, then component values would be calculated as follows: Worker A=80=2% (20% of max); Worker B=50 times=5% (50% of max); Worker C=null=times=5% (50% of max); and Worker D=10 times=9% (90% of max). In an instance where there is no worker value such as Worker C, the midpoint of the max value for the give component may be used.

At step 510, the total worker score using the foregoing components for the above workers may be determined using a processer. The total worker score may be calculated as follows: Worker A=74; (74% of max); Worker B=47.5 (47.5% of max); Worker C=35 (35% of max); and Worker D=54 (54% of max). The worker scores may then be used to determine a sort order or offer transmission sequence.

In other aspects, the score computing algorithm may compute an attribute component score, which may be the score for each attribute in the profile. The attribute component score values may be computed based on attribute specific matching factors. The attribute component may be initially set to zero. A unit score between zero and one may be determined as the reciprocal of the number of attribute values which exist for the attribute. For example, if there are 5 components associated with an attribute then the unit score may be 0.2. Thereafter, the score computing algorithm may consider the priority values associated with each component of the attribute. The values assigned with a high priority value may be multiplied with a higher weight factor than the values assigned with a lower priority value. For example, a priority of 5 may be assigned to a value v1 and priority of 3 may be assigned to the value v2, the attribute component score would be 0.2×0.5+0.2×0.3=0.16. In this manner, the attribute component score may be computed for all the attributes in the profile. Finally, the individual attribute component score may be added to determine the final score, which may be then assigned to the worker or the employer. The final score value may be used for matching the profiles of workers with appropriate jobs and the employers with appropriate candidates.

In some embodiments, the matching service may predict a likelihood of a match corresponding to a worker. Further, the prediction may be performed based on an analysis of each of the plurality of worker values and an employer priority. Further, the matching service may consider the parameters such as, but not limited to, attributes, values and priority values of the attribute and values a prediction of likelihood of match may be computed. Furthermore, the matching service may include one or more statistical classification algorithms for classifying the job profiles of one or more workers based on the one or more aforementioned parameters. The statistical classification algorithms may include Max Diff, Naïve Bayes classifier, K nearest neighbor classifier, Random forests and the like. The classification feature may provide efficient profile matching.

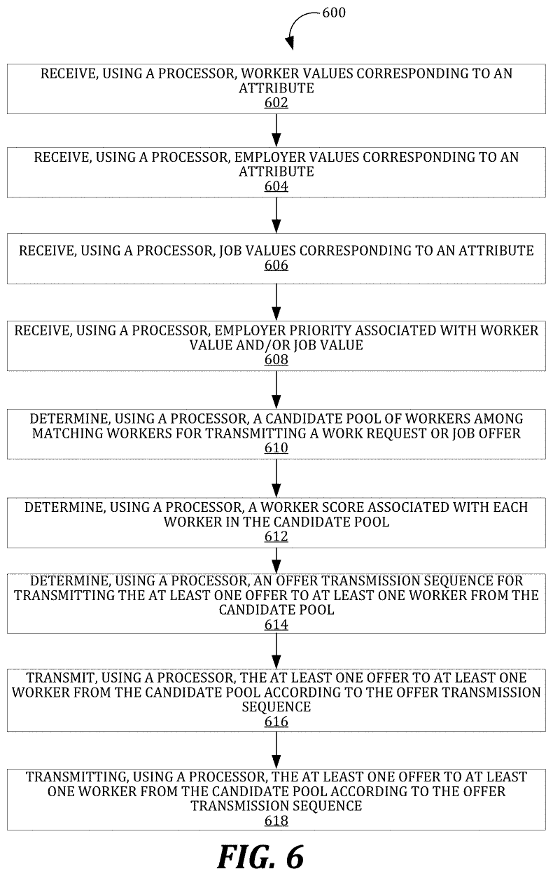

FIG. 6 illustrates a flow diagram of the method steps for transmitting work request to workers most suitable for an employer, in accordance with some embodiments. For the explanation for steps 602 through 612, one may refer to the FIG. 2 (steps 202-212). At step 614, an offer transmission sequence may be determined, using a processor. The sequence may be computed by considering the values of the attributes associated with the employer relative to the worker score. Additionally, the sequence may be determined using worker scores computing by considering the employer priority associated with the values of the employer attributes.

At step 616, at least one work request or job offer to at least one worker from the candidate pool according to the offer transmission sequence. The offer transmission sequence may comprise parameters for transmission of offers to the workers. In various aspects, the offers may be transmitted sequentially or one at a time. In some aspects, a job offer or work request is released or transmitted to a first worker for a first predetermined period of time. If the job offer or work request is not accepted by the worker within the first predetermined period of time, the job offer or work request is terminated or otherwise retracted from the first worker and distributed to a second worker for a second predetermined period of time. The first and second predetermined periods of time may be the same or different. For example, the predetermined period of time may decrease with transmissions to each subsequent worker. In further aspects, the parameters for transmission may include at least one of: available wait times (AWT) (e.g., total time to get through offer), and may vary among different pools, enterprises and/or marketplaces; Available Pool—(e.g., total number of workers to receive the offer or available pool of workers from candidate pool determined to be eligible for receiving job offer or work request). The available pool may comprise pre-existing pool or may be established using a pick list. In some aspects, the available pool may be determined when offer is submitted and not added to as the offer is distributed; Max Distribution Time (MDT), which may allow control of the maximum point relative to AWT that all offers must be transmitted, for example, to prevent waiting to the end of AWT to transmit all offers. This parameter may be set as either a percent of the AWT or an actual time (e.g., 30, 45, 60, 75, 90, or 120 minutes) or a lesser of the two if both are utilized; Offer Interval Spacing (OIS) which comprises the time between each job offer release or subsequent transmission of job offer to worker, such as when job offer or work request remains unfulfilled . A baseline parameter may be calculated as follows: Max Distribution Time/Available Pool=OIS. In other aspects, the value may be manually entered. In further aspects, a Max OIS may be used to allow configuration to create a speedier path through the offer sequence when long AWT exits. In still further aspects, a Min OIS may be used to allow configuration to create a forced staggering. In some aspects, platform users may be encouraged to only use Max OIS since it assures offers will get out faster. In other aspects, platform users of Min OIS may be able to prevent certain workers from ever seeing an offer.

In further aspects, workers may become disqualified for an offer as the sequence progresses, for example due to a calendar conflict or location change, or the like. In such instances, the platform may proceed to the next candidate worker in the sequence. In some aspects, when assessing the distribution of a job offer, worker scores may be calculated for each session and then sum all worker scores of qualified workers together to determine job offer distribution.

In further aspects, the platform may use appropriate machine learning algorithms for learning the characteristics of the best matching profile. The machine learning algorithms may be trained, using supervised or unsupervised training methods, to learn the parameters of the best matching profile and the least matching profiles. After the training phase, the profile matching algorithm may automatically rank the best matching profiles. The profile matching algorithm when combined with a machine learning algorithm may automatically adjust the profile matching parameters as and when the requirements of the workers and employers change. To this end, the platform may log historical data such as each calculated worker score and relative component values scores in each offer for use in future analysis and learning functions.

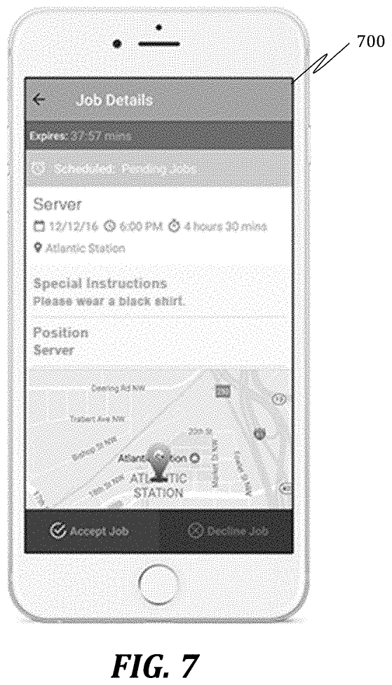

FIG. 7 illustrates an exemplary view 700 of the platform provided to a worker in accordance with various embodiments. The view 700 illustrates a view provided by the matching service to the worker. The view may be a graphical user interface (GUI) with which the worker may interact with. The GUI may be rendered on stationary or handheld computing devices, such as, but not limited to laptops, mobiles and workstations. The view 700 may indicate the details of a work request transmitted to the worker. The view 700 may include a column which may comprise the details of the job. Further, the column may include an accept button, which when pressed by the worker transmits, using a processor, a job acceptance to at least one employer corresponding to the at least one job posting. The job posting may include the job profile which may include all the details as desired by the employer.

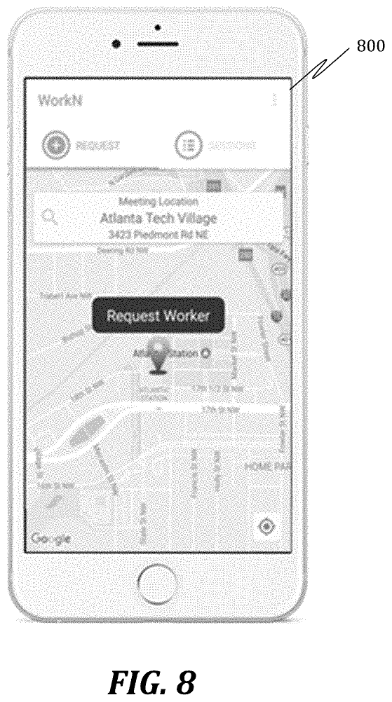

FIG. 8 illustrates an exemplary view 800 of the platform provided to an employer in accordance with various embodiments. In some aspects, view 800 may include a work request or job offer transmission button, which when activated by the employer transmits a work request or job offer to one worker corresponding to the job profile, where the request may include the job posting. In other aspects, the offer transmission may be done according to an offer transmission sequence.

In further aspects, an employer may receive one or more worker profiles from a candidate pool. In still further aspects, the displaying of worker profiles may be performed based on the worker score associated with each worker. The view may include a column with the names of the most suitable candidate workers for a particular job opening or open shift posted by the employer. Further, column may include one or more details of the workers. The employer may be able to view the details of the workers. In some embodiments, profile data corresponding to a worker may be retrieved automatically from one or more databases. For example, the profile data of the worker may be generated using a government database. In yet further aspects, view 800 may include a column that may indicate the score match between the profiles of the worker with that of the job. The worker profiles may be ranked based on the score match.

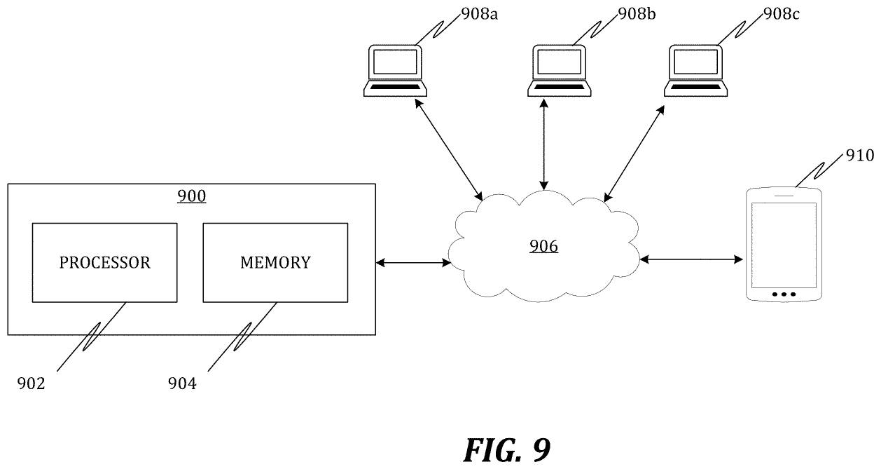

FIG. 9 illustrates a block diagram of a system 900 for matching workers with employers according to various embodiments. In some embodiments, the system 900 may include a server for processing requests from client devices. The system 900 may include a processor 902 and a memory 904. Further, the system 900 may be configured to communicate over a communication network 906 which may be an instance of network 110 as explained in conjunction with FIG. 1. Accordingly, in some embodiments, the system 900 may include a network interface module (not shown in figure). In some other embodiments, the communication network 906 may be an internal system bus. Additionally, the system 900 may be configured to communicate with one or more client devices 908, such as 908a, 908b and 908c. Further, in some embodiments, the communication may take place over the communication network 906.

Further, the memory 904 may be communicatively coupled to the processor 902. Further, the memory 904 may be configured to store a program code which when executed by the processor, causes the system 900 to match workers with employer and/or employer's job based on a worker score. Further, the program code, when executed, may cause the system 900 receive a plurality of worker values corresponding to an attribute of a plurality of attributes. Further, the program code, when executed, may cause the system 900 to receive a plurality of employer values corresponding to the attribute of the plurality of attributes. Further, the program code, when executed, may cause the system 900 to receive at least one employer priority associated with at least one employer value of the plurality of employer values. Further, the system 900 may be configured to determine a worker score associated with each worker. The worker score may be determined based on each of a comparison of the plurality of worker values and a comparison of worker priority with the employer attribute and/or priority.

While various embodiments of the disclosed methods and systems have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

### D. Profile Matching Server Architecture

Platform 100 may be embodied as, for example, but not be limited to, a website, a web application, a desktop application, and a mobile application compatible with a computing device. The matching server 100 may comprise, but not be limited to, a desktop computer, laptop, a tablet, or mobile telecommunications device. Moreover, the platform 100 may be hosted on a centralized server, such as, for example, a cloud computing service. Although the disclosed methods have been described to be performed by the matching server 100, it should be understood that, in some embodiments, different operations may be performed by different networked elements in operative communication with the matching server 100.

Embodiments of the present disclosure may comprise a system having a memory storage and a processing unit. The processing unit coupled to the memory storage, wherein the processing unit may be configured to perform the stages of the disclosed methods.

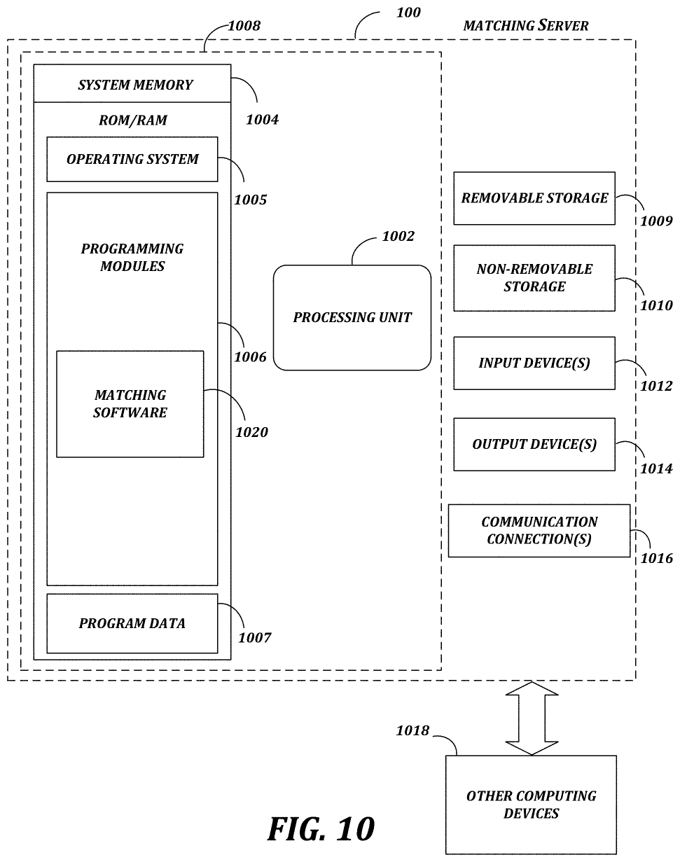

FIG. 10 is a block diagram of a system including matching server 100. Consistent with various embodiments of the disclosure, the aforementioned memory storage and processing unit may be implemented in a computing device, such as matching server 100 of FIG. 1. Any suitable combination of hardware, software, or firmware may be used to implement the memory storage and processing unit. For example, the memory storage and processing unit may be implemented with matching server 100 or any of other computing devices 1018, in combination with matching server 100. The aforementioned system, device, and processors are examples and other systems, devices, and processors may comprise the aforementioned memory storage and processing unit, consistent with embodiments of the disclosure.

With reference to FIG. 10, a system consistent with various embodiments of the disclosure may include a computing device, such as matching server 100. In a basic configuration, matching server 100 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling profile matching server 100's operation. In one embodiment, programming modules 1006 may include profile matching software 1020. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Matching server 100 may have additional features or functionality. For example, matching server 100 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and nonvolatile, removable and non-removable media implemented in any method or technology for storage of information, such as computer readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the matching server 100. Any such computer storage media may be part of the matching server 100. Matching server 100 may also have input device(s) 1012 such as a keyboard, a mouse, a pen, a sound input device, a touch input device, etc. Output device(s) 1014 such as a display, speakers, a printer, etc. may also be included. The aforementioned devices are examples and others may be used.

Matching server 100 may also contain a communication connection 1016 that may allow matching server 100 to communicate with other computing devices 1018, such as over a network in a distributed computing environment, for example, an intranet or the Internet. Communication connection 1016 may be one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., profile matching software 1020) may perform processes including, for example, one or more stages of the disclosed methods as described above. The aforementioned process is an example, and processing unit 1002 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks may be performed by remote processing devices that may be linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. Insofar as the description above and the accompanying drawing disclose any additional subject matter that is not within the scope of the claims below, the disclosures are not dedicated to the public and the right to file one or more applications to claims such additional disclosures is reserved.

What is claimed:

1. A method for matching job offers with workers, the method comprising:
receiving, by a system having at least one processor, a plurality of worker values corresponding to a plurality of attributes;
receiving, by the system, a plurality of employer values corresponding to the plurality of attributes;
receiving, by the system, at least one employer priority associated with one or more employer values from the plurality of employer values;
determining, by the system, a worker score associated with each worker of a plurality of workers, wherein a worker score associated with a worker is determined based on each of a comparison of the plurality of worker values with the plurality of employer values and a comparison of the plurality of worker values with the at least one employer priority;
determining, by the system, a candidate pool of workers from the plurality of workers meeting predetermined criteria; and
transmitting, by the system, at least one job offer to at least one worker among the candidate pool.

2. The method of claim 1, wherein a worker score associated with a worker of the plurality of workers is determined based on at least one of: work radius, average star rating, average star rating with enterprise, average star rating with location, average star rating with requester, average star rating with sessions of given attributes, overtime propensity, work history with enterprise, work history with marketplace, work history with requester, work history with location, current proximity, and proximity of closest ending session.

3. The method of claim 2, further comprising receiving, by the system, a selection of the plurality of attributes from at least one of: a worker or an employer.

4. The method of claim 3, further comprising receiving, by the system, at least one employer priority corresponding to at least attribute of the plurality of attributes, wherein the worker score is determined based further on a comparison of the at least one employer priority corresponding to the at least attribute.

5. The method of claim 4, further comprising displaying, by the system, a plurality of worker profiles corresponding to the plurality of workers, wherein the displaying is performed based on the worker score associated with each worker of the plurality of workers.

6. The method of claim 5, wherein displaying is performed in response to posting a job by an employer.

7. The method of claim 6, further comprising determining, by the system, an offer transmission sequence for transmitting the at least one job offer based on at least one transmission parameter selected from available wait times (AWT), an available pool of workers from the candidate pool for receiving the at least one job offer; a maximum distribution time (MDT) for transmission of the at least one job offer, and an offer interval spacing (OIS) between transmission of the at least one job offer from a worker to a next worker; and
transmitting, by the system, the at least one job offer to at least one worker from the candidate pool for a predetermined period of time according to the offer transmission sequence.

8. The method of claim 7, further comprising receiving, by the system, at least one transmission parameter for transmitting the at least one job offer; and
transmitting, by the system, the at least one job offer to at least one worker from the candidate pool for a predetermined period of time according to the job offer transmission sequence and said at least one transmission parameter.

9. The method of claim 8, further comprising detecting, by the system, a disqualifying conflict associated with the at least one worker based on at least one of: the plurality of worker values or a plurality of worker priorities of the at least one employer priority; and
terminating or bypassing transmission of the at least one job offer to said worker.

10. The method of claim 8, further comprising predicting, by the system, a likelihood of a match corresponding to a worker of the plurality of workers, wherein the predicting is performed based on an analysis of each of the plurality of worker values and the at least one employer priority.

11. The method of claim 7, further comprising receiving, by the system, an acceptance input corresponding to the at least one job offer; and
transmitting, by the system, a job profile associated with the at least one job offer.

12. A computer-readable, non-transitory storage medium having a set of computer accessible instructions which when executed, cause at least one processor to perform operations comprising:
receiving a plurality of worker values corresponding to a plurality of attributes;
receiving a plurality of employer values corresponding to the plurality of attributes;
receiving at least one employer priority associated with one or more employer values from the plurality of employer values;
determining a worker score associated with each worker of a plurality of workers, wherein a worker score associated with a worker is determined based on at least one of: work radius, average star rating, average star rating with enterprise, average star rating with location, average star rating with requester, average star rating with sessions of given attributes, overtime propensity, work history with enterprise, work history with marketplace, work history with requester, work history with location, current proximity, and proximity of closest ending session;
determining a candidate pool of workers meeting predetermined employer criteria associated with the plurality of attributes;
determining an offer transmission sequence for sequentially transmitting at least one job offer to one or more workers based on transmission parameters including: available wait times (AWT), available pool of workers from the candidate pool for receiving the at least one job offer; maximum distribution time (MDT) for transmission of the at least one job offer, and offer interval spacing (OIS) between transmission of the at least one job offer from a worker to a next worker; and
transmitting the at least one job offer to at least one worker from the available pool for a predetermined offer interval period and according to the offer transmission sequence.

13. The medium of claim 12, wherein the operations further comprise identifying a disqualifying conflict associated with at least one worker in the offer transmission sequence based on at least one of: the plurality of worker values or a plurality of worker priorities of the at least one employer priority; and
terminating or bypassing transmission of the at least one job offer to said worker.

14. The medium of claim 13, wherein the operations further comprise sequentially transmitting the at least one job offer to workers from the available pool for the predetermined offer interval period and according to the offer transmission sequence until a worker accepts the job offer.

15. The medium of claim 14, wherein the offer interval spacing is determined by dividing max distribution time by the number of workers in the available pool.

16. A system, comprising:
at least one memory having computer-accessible instructions; and
at least one processor functionally coupled to the at least one memory and configured by at least a portion of the computer-accessible instructions to:
receive a plurality of worker values corresponding to a plurality of attributes;
receive a plurality of employer values corresponding to the plurality of attributes;
receive at least one employer priority associated with one or more employer values from the plurality of employer values;
determine a worker score associated with each worker from a plurality of workers, wherein a worker score associated with a worker is determined based on each of a comparison of the plurality of worker values with the plurality of employer values and a comparison of at least one worker value with the at least one employer priority;
determine a candidate pool of workers meeting predetermined criteria from the plurality of workers;
determine an offer transmission sequence for sequentially transmitting at least one work request to a worker based on transmission parameters comprising: available wait times (AWT), available pool of workers from the candidate pool for receiving the at least one work request; maximum distribution time (MDT) for transmission of the at least one work request, and offer interval spacing (OIS) between transmission of the at least one work request from a worker to a next worker; and
transmit the at least one work request to a first worker from the available pool for a first predetermined period of time according to the offer transmission sequence.

17. The system of claim 16, wherein if the at least one work request is not accepted by the first worker within the first predetermined period of time, transmit the at least one work request to a second worker from the available pool for a second predetermined period of time according to the offer transmission sequence.

18. The system of claim 17, wherein the worker score associated with a worker is determined based on at least one of: work radius, average star rating, average star rating with enterprise, average star rating with location, average star rating with requester, average star rating with sessions of given attributes, overtime propensity, work history with enterprise, work history with marketplace, work history with requester, work history with location, current proximity, and proximity of closest ending session.

19. The system of claim 18, wherein the at least one processor is further configured to receive an acceptance input from a worker corresponding to the at least one work request; and
transmit a job profile associated with the at least one work request.

20. The system of claim 19, wherein the at least one processor is further configured to receive a completion input corresponding to the at least one work request; and
transmit a completion notification associated with the at least one work request.
